(19) United States
(12) Patent Application Publication
(10) Pub. No.: US 2006/0154142 A1
(43) Pub. Date: Jul. 13, 2006

(54) New-type Ni-MH power battery

(75) Inventors: Zichun Xu, Shenzhen City (CN); Zhenggang Fan, Shenzhen City (CN)

Correspondence Address: CHARLES E. BAXLEY, ESQ., 90 JOHN STREET, THIRD FLOOR, NEW YORK, NY, 10038, US

(73) Assignee: Shenzhen Grepow Battery Co., Ltd.

(21) Appl. No.: 11/324,689

(22) Filed: Jan. 3, 2006

(30) Foreign Application Priority Data
Jan. 11, 2005 (CN) 200520053766.2

(51) Int. Cl. H01M 2/26; H01M 4/74; H01M 4/66

(52) U.S. Cl. 429/161; 429/211; 429/241; 429/245

(57) ABSTRACT

The present invention provides a new-type Ni-MH power battery, which includes a battery vent cap 1, a metal can 2, a positive electrode current collector 3 and a negative electrode current collector 4 inside the can 2, and an electrode assembly 5 generally formed by winding a positive electrode plate 10, a separator 7, and a negative electrode plate 11 having a copper mesh as a substrate. The upper and lower surface of the positive electrode current collector 3 are connected to the lower surface of the battery vent cap 1 and a positive electrode 6 of the electrode assembly 5 via welding spots 8 respectively. The lower surface of the negative electrode current collector 4 is connected to the inner surface of the can 2 via multiple welding spots 8. The upper surface of the negative electrode current collector 4 contacts a negative electrode 9 of the electrode assembly via a layer of metal foam conductor 12, in which the negative electrode 9 is embedded in the metal foam conductor 12. The invention is beneficial to high-current discharge, and has favorable current collecting effect, low cost, large capacity, high power/volume ratio, high energy/volume ratio, and outstanding comprehensive battery performance.

### BACKGROUND OF THE PRESENT INVENTION

1. Field of Invention

The present invention relates to a rechargeable Ni-MH battery, and more particularly to a Ni-MH power battery.

2. Description of Related Arts

Electric vehicles are widely accepted because of the advantages of no exhaust emission, low noise, and being friendly to environment, and have considerable development prospects. Ni-MH power batteries providing power to electric vehicles have attracted great attention due to the advantages of outstanding comprehensive performance, capability of satisfying high power start-up required by electric vehicles, wide operating temperature range, recharge ability without memory effect, and no heavy metals such as cadmium and lead exhausted.

Conventional Ni-MH battery has a battery vent cap 1, a metal can 2, positive electrode and negative electrode current collector 3, 4 inside the can 2, and an electrode assembly 5 formed by winding a positive electrode plate 10, a separator 7 and a negative electrode plate 11. The upper and lower surfaces of the positive electrode current collector 3 are connected to the lower surface of the battery vent cap 1 and a positive electrode 6 of the electrode assembly 5 via welding spots 8 respectively. The upper surface of the negative electrode current collector 4 is connected to a negative electrode 9 of the electrode assembly 5 via welding spots 8, and the lower surface of the negative electrode current collector 4 is connected to the inner surface of the can 2 via one welding spot 8. A nickel sheet 16 is respectively seam-welded at one end of the positive electrode and negative electrode 6, 9 connected to the positive electrode and negative electrode current collector 3, 4, as shown in FIG. 1. The battery is generally manufactured by taking nickel foams as the substrate of the positive electrode and the negative electrode of the battery, and pasting, pressing, or sintering corresponding active materials on the substrate respectively. A rolled edge with a width of 8-10 mm is left along the long side of each substrate. The rolled edge is not coated with active material, but is seam-welded with a sheet of nickel. Before winding, the nickel-sheet of the positive electrode and the negative electrode are disposed in opposite directions. Then, after being insulated by a separator, the positive electrode and the negative electrode are wound, with the edges of the nickel-sheet at two ends of the electrode assembly respectively. The electrode assembly is bound by an adhesive tape to prevent loosening. At each end face of the nickel-sheet edges at both ends of the electrode assembly, a current collector is spot-welded. One end of the negative electrode of the electrode assembly is inward inserted in the can. A spot-weld pin penetrates through the electrode assembly, and accordingly the negative electrode current collector is spot-welded on the inner surface of the can via a welding spot. After beading the can and filling with electrolyte, the positive electrode current collector is spot-welded on the battery vent cap. After crimping and sealing, a battery is thus formed.

A Ni-MH power battery of such structure has the shortcomings of high cost due to that it consumes a lot of expensive nickel material, and has a complicated manufacturing process. The negative electrode current collector contacts the metal can only via one welding spot, so it cannot bear a high current. The adhesive tape is bound on the outer layer of the electrode assembly, taking up a certain space, thus resulting in small capacity, low power/volume ratio, and low energy/volume ratio of the battery.

### SUMMARY OF THE PRESENT INVENTION

Accordingly, to overcome the disadvantages mentioned above, an object of the present invention is to provide a new-type Ni-MH power battery having the characteristics of favorable current collecting effects and being easy to high-current discharge.

The battery also has the characteristics of large capacity, high power/volume ratio and energy/volume ratio, and low manufacturing cost.

The technical scheme of the present invention is to design a new-type Ni-MH power battery, which comprises a battery vent cap, a metal can, positive electrode and negative electrode current collector inside the can, and an electrode assembly formed by winding a positive electrode plate, a separator and a negative electrode plate. The upper surface of the positive electrode current collector is connected to the lower surface of the battery vent cap, and the lower surface of the positive electrode current collector is connected to the positive electrode end face of the electrode assembly via welding spots. The upper surface of the negative electrode current collector contacts the negative electrode of the electrode assembly. Two or more weld spots for connection are designed instead of the one weld spot for connection between the negative electrode current collector and the metal can in the conventional arts.

A metal foam conductor is also provided between the negative electrode of the electrode assembly and the negative electrode current collector, the negative electrode is embedded in the metal foam conductor.

In one embodiment, the metal foam conductor is nickel foam.

In another embodiment, the negative electrode plate structure includes a metal mesh or a punched metal strip as the substrate. The substrate is pasted with active materials on both sides. The metal mesh includes a copper mesh, a copper alloy mesh, a nickel mesh, a nickel-plated steel mesh, or any other metal meshes. The metal strip includes a copper strip, a copper alloy strip, a nickel strip, a nickel-plated steel strip, or any other metal strips.

In another embodiment, the negative electrode current collector has one or more through holes with burrs on the peripheral, in which the burrs contact the metal foam conductor. No adhesive tape is on the outer layer of the electrode assembly.

As the present invention employs a structure of two or more welding spots between the negative electrode current collector and the metal can, a metal foam conductor between the negative electrode of the electrode assembly and the negative electrode current collector, as well as a metal mesh or a punched metal strip as the substrate of the negative electrode plate. The present invention has the advantages of favorable current collecting effects and is beneficial for high-current discharge. Furthermore, omitting seam-welded nickel sheets on both ends of the positive electrode and the negative electrode and the binding wires or adhesive tapes on the outer layer of the electrode assembly, the present invention has a simple manufacturing process and the low costs, but also has advantages of large capacity, high power/volume ratio, high energy/volume ratio, and outstanding comprehensive battery performance.

### BRIEF DESCRIPTION OF THE DRAWINGS

FIG. 1 is a schematic sectional view of a conventional Ni-MH power battery;

FIG. 2 is a schematic sectional view of a new-type Ni-MH power battery of the present invention; and

FIG. 3 is a schematic spatial view of the structure of the new-type negative electrode current collector of the present invention.

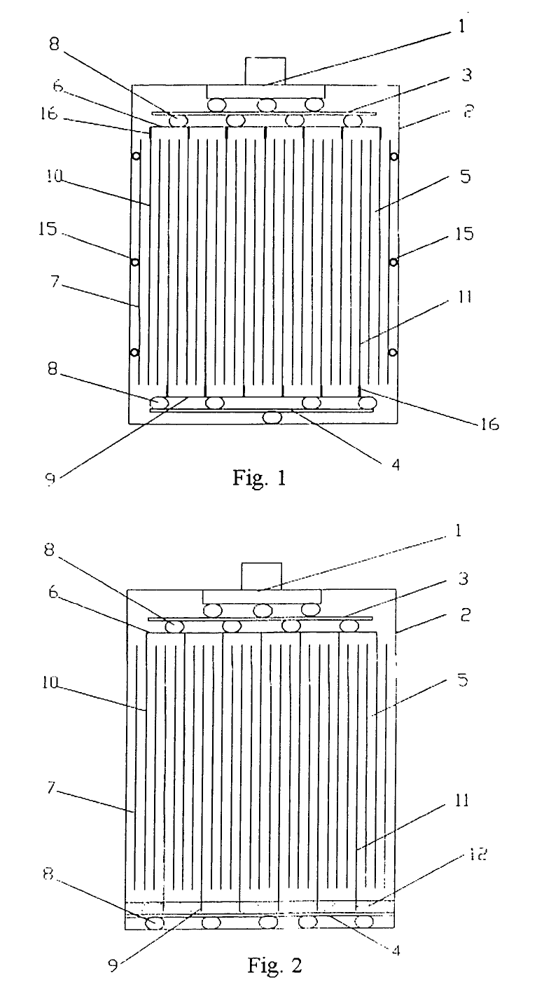

### DESCRIPTION OF THE PREFERRED EMBODIMENTS

Referring to FIG. 2, a schematic sectional view of a new-type Ni-MH power battery is illustrated. As shown in the figure, the new-type Ni-MH power battery includes a battery vent cap 1, a can 2, positive electrode and negative electrode current collector 3, 4 inside the can 2, and an electrode assembly 5 formed by winding a positive electrode plate 10, a separator 7, a negative electrode plate 11 having a copper mesh as the substrate. The upper and lower surfaces of the positive electrode current collector 3 are connected to the lower surface of the battery vent cap 1 and a positive electrode 6 of the electrode assembly 5 via welding spots 8 respectively. A negative electrode 9 of the electrode assembly 5 is embedded in a metal foam conductor 12. The upper surface of the negative electrode current collector 4 is connected to the metal foam, while the lower surface of the negative electrode current collector 4 is connected to the inner surface of the can 2 via several welding spots 8.

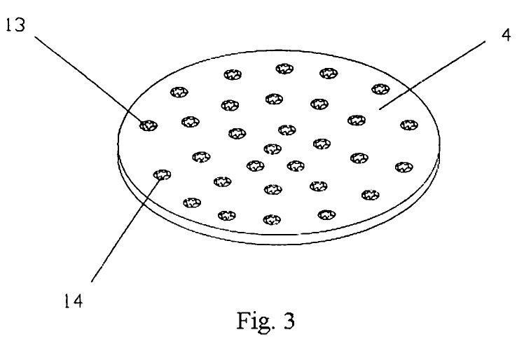

A schematic structural view of the negative electrode current collector 4 is described in FIG. 3. As shown in the figure, the negative electrode current collector 4 is provided with several circular through holes 13 with burrs 14 on the circumference.

Of course, the through holes 13 can also be designed to be other geometrical shapes, such as square, diamond, heart, triangle, ellipse, quincunx, or any other shapes.

What is claimed is:

1. A new-type Ni-MH power battery, comprising: an upper battery vent cap, a metal can, a positive electrode current collector, a negative electrode current collector inside the can, and an electrode assembly formed by winding a positive electrode plate, a separator, and a negative electrode plate, an upper surface of the positive electrode current collector being connected to a lower surface of the battery vent cap, and a lower surface of the positive electrode current collector being connected to the end of a positive electrode of the electrode assembly via welding spots; a lower surface of the negative electrode current collector being connected to an inner surface of the can via a plurality of welding spots; wherein an upper surface of the negative electrode current collector contacts a negative electrode of the electrode assembly, and two or more welding spots are provided between the negative electrode current collector and the metal can.

2. The new-type Ni-MH power battery according to claim 1, wherein the negative electrode of the electrode assembly contacts the negative electrode current collector via a layer of metal foam conductor, the negative electrode being embedded in the metal foam conductor.

3. The new-type Ni-MH power battery according to claim 2, wherein the metal foam conductor is nickel foam.

4. The new-type Ni-MH power battery according to claim 1, wherein the negative electrode plate has a metal mesh or a punched metal strip as a substrate, the substrate having active material pasted on both sides.

5. The new-type Ni-MH power battery according to claim 2, wherein the negative electrode plate has a metal mesh or a punched metal strip as a substrate, the substrate having active material pasted on both sides.

6. The new-type Ni-MH power battery according to claim 4, wherein the metal mesh is a copper mesh, a copper alloy mesh, a nickel mesh, or a nickel-plated steel mesh.

7. The new-type Ni-MH power battery according to claim 5, wherein the metal mesh is a copper mesh, a copper alloy mesh, a nickel mesh, or a nickel-plated steel mesh.

8. The new-type Ni-MH power battery according to claim 4, wherein the metal strip is a copper strip, a copper alloy strip, a nickel strip, or a nickel-plated steel strip.

9. The new-type Ni-MH power battery according to claim 5, wherein the metal strip is a copper strip, a copper alloy strip, a nickel strip, or a nickel-plated steel strip.

10. The new-type Ni-MH power battery according to claim 6, wherein the negative electrode current collector has one or more through holes with burrs on the peripheral, the burrs contacting the metal foam conductor.

11. The new-type Ni-MH power battery according to claim 7, wherein the negative electrode current collector has one or more through holes with burrs on the peripheral, the burrs contacting the metal foam conductor.

12. The new-type Ni-MH power battery according to claim 8, wherein the negative electrode current collector has one or more through holes with burrs on the peripheral, the burrs contacting the metal foam conductor.

13. The new-type Ni-MH power battery according to claim 9, wherein the negative electrode current collector has one or more through holes with burrs on the peripheral, the burrs contacting the metal foam conductor.
